(19) United States
(12) Patent Application Publication
(10) Pub. No.: US 2007/0133436 A1
(43) Pub. Date: Jun. 14, 2007

(54) Audio bridge for network conferencing

(75) Inventors: Joseph E. Provino, Arlington, MA (US); Jonathan H. Kaplan, Cambridge, MA (US)

Correspondence Address: CHAPIN INTELLECTUAL PROPERTY LAW, LLC, WESTBOROUGH OFFICE PARK, 1700 WEST PARK DRIVE, WESTBOROUGH, MA, 01581, US

(73) Assignee: Sun Microsystems, Inc., Santa Clara, CA (US)

(21) Appl. No.: 11/298,260

(22) Filed: Dec. 9, 2005

(51) Int. Cl. H04L 12/16

(52) U.S. Cl. 370/260

(57) ABSTRACT

An audio management apparatus manages simultaneous streams of packet-switched audio data for a network conference tool. The apparatus uses a receiver thread to receive packets input from different audio connection points, and a sender thread to send modified packets to the audio connection points. The apparatus uses a plurality of member objects, each associated with a different connection point, to modify the packets to create a custom mix of audio data for each connection point. A common mix, consisting of all of the packets input from all of the connection points, is also maintained, and is used by each of the member objects, along with the packets maintained by the member objects, to perform the desired mixing. The overall number of receiver threads and sender threads is independent of the number of member objects, thereby allowing the system to be highly scalable.

### FIELD OF THE INVENTION

This invention is directed, generally, to the field of network conferencing systems for use on a digital network and, more specifically, to audio communications on such systems.

### BACKGROUND OF THE INVENTION

With the rise of networked computing systems, particularly in business settings, new tools have emerged that allow network users, or clients, to interact with one another in various ways. Email, for example is a ubiquitous communication means which allows text messages to be communicated selectively over a network. Similarly, instant messaging and text-based “chats” have proven popular tools for communicating textual information between network clients. More recently, audio communication has been used over digital networks, the best-known format being the “voice-over-internet protocol” (VoIP). Even video conferencing has been used over digital networks, to varying degrees of success.

Collaboration software, sometimes referred to as “groupware” is designed to allow multiple network users to work on a single project together from separate workstations. One version of such software is “NOTES” which is a registered trademark and product of Lotus Development Corporation, Cambridge, Mass. Another is “NETMEETING” which is a registered trademark and product of Microsoft Corporation, Redmond, Wash. The goal of these products is to allow conferencing between multiple network clients, and collaboration among those clients in which they interact to manipulate a target such as a document or “whiteboard.” However, while improvements have been made in these products, there are areas in which the ability of users to communicate or collaborate may be improved.

### SUMMARY OF THE INVENTION

In accordance with the present invention, an audio management apparatus is provided that manages simultaneous streams of packet-switched audio data for a network conference tool. The tool provides communication between a plurality of different connection points, with audio data being received from and transmitted to the connection points by the audio management apparatus. The connection points may be audio receiving/transmitting devices used by a participant in a network conference. The audio management apparatus may be one of a number of similar components that are used with a single network conference tool, allowing multiple conferences to be managed simultaneously. The audio management apparatus includes a plurality of member objects, each being associated with a different one of the connection points. Each of the member objects maintains a mixing protocol for audio data to be delivered to the connection point with which it is associated. Thus, for each conference participant, there is an independent tracking of the specific mix for the audio content that should be delivered to that participant.

The audio management apparatus includes a receiver that receives each packet of audio data delivered from the connection points. The receiver identifies the connection point (such as an audio connection for a conference participant) that is the source of the packet, and forwards the packet to the member object that is associated with that connection point. Thus, there is a receiver thread that controls the packets input to the audio management apparatus, and services any number of different member objects. There may be more than one receiver thread to divide up the tasks, but the number of receiver threads is independent of the number of member objects.

The audio management apparatus also includes a sender that processes each packet of audio data from each member object and transmits each packet to the respective connection point with which that packet is associated. The sender may also be a single thread that supports all of the member objects and, along with the thread used for the receiver, allows there to be a variable number of member objects, and therefore a scalable number of conference participants. As with the receiver, there may be more than one sender thread, so as to divide up the processing tasks, but the number of sender threads is also independent of the number of member objects. Thus, conference participants may be easily added or removed without affecting the system operation.

The member objects of the system handle the mixing of the audio data for the connection point that they represent. Upon receiving a packet from the receiver, a member object decodes the packet and appends it to a list maintained by that object. The packet is also added to a common mix that is maintained by a common mix object. The common mix is a list of audio data packets each comprising a combination of audio data packets of a plurality of the member objects for one particular time segment. The common mix may be a mix of all of the combined contributions of audio data received from all of the connection points, or may be a mix of less than all, as desired for the particular audio mixing strategy. The common mix packets may be used along with the packets maintained by the member objects for creating output audio mixes.

Prior to forwarding a packet to the sender, each member object creates the data packet such that it corresponds to the custom mix for the connection point it represents. This custom mix is defined by the conference tool which, under user control, establishes the desired audio connections between participants, and sends mixing instructions to the member objects. In performing the mixing, each member object has access to the data packets of the other member objects, and can add and subtract packets, including the common mix packets, from one another to achieve the desired audio mix. For example, a packet might be modified to subtract the contribution of the connection point with which the member object is associated, or the contribution of another participant that is involved in a private subgroup conference might be subtracted. Once modified, the packets are output by the sender thread to their appropriate connection points. As such, the packets delivered to a particular connection point have all been modified according to the mixing protocol maintained by the member object associated with that connection point.

### BRIEF DESCRIPTION OF THE DRAWINGS

The above and further advantages of the invention may be better understood by referring to the following description in conjunction with the accompanying drawings in which:

FIG. 1 is a graphical depiction of a network collaboration system environment typical of the present invention;

FIG. 2 is a schematic view of an audio bridge for a collaboration tool environment like that of FIG. 1;

FIG. 3 is a schematic overview of a conference manager that may be used with the audio bridge of FIG. 2;

FIG. 4 is a graphical depiction of an audio mixing strategy that may be used with the present invention;

FIG. 5 is a graphical depiction of an audio mixing strategy similar to FIG. 4 at a time when several audio inputs are muted;

FIG. 6 is a graphical depiction of an audio mixing strategy similar to FIG. 4 at a time when a subgroup conference is taking place among several meeting participants;

FIG. 7 is a graphical depiction of the audio packet input functionality of a conference manager according to the present invention; and

FIG. 8 is a graphical depiction of an audio packet output functionality of a conference manager according to the present invention.

### DETAILED DESCRIPTION

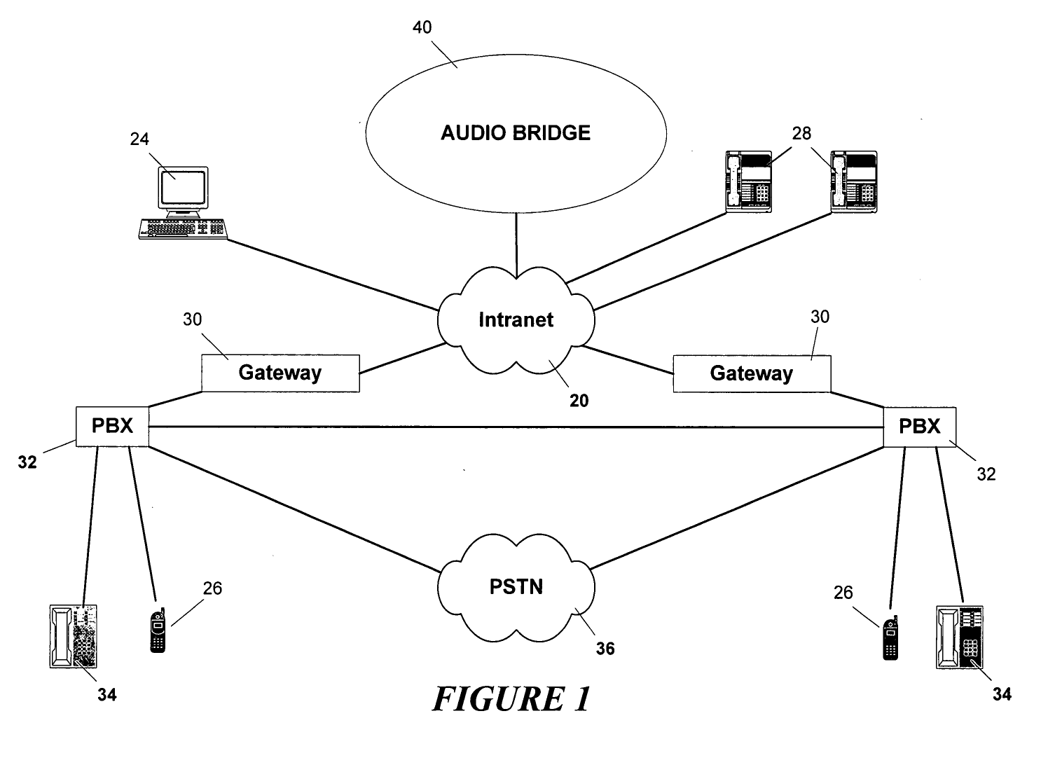

The present invention may be used with a collaboration tool that operates around a general backbone architecture that allows various access points and functionality. Shown in FIG. 1 is a general overview of some of that accessibility. A digital network, such as intranet 20, can serve as the host for the collaboration tool, and a primary connection medium for the system. Operating with the intranet is audio bridge 40, which provides audio interconnection between a variety of different connection points. Such connection points may include workstation 24, which may host a software phone, and IP phones 28, such as model 7960 produced by Cisco Systems, Inc. These different communications points all transmit and receive data via the intranet 20, and allow a user audio access to the collaboration tool. Also connected to the intranet of FIG. 1 are gateways 30, each of which provide connection to private branch exchange (PBX) switches 32 that each service a number of conventional telephone sets 34 or wireless phones (or other wireless audio devices) 26. The PBX switches 32 may also be connected to a public service telephone network (PSTN) 36, which operates according to conventional telephony principles, as well as to each other, if the two switches are part of a common internal switching network. Those skilled in the art will recognize that the various connection points shown in FIG. 1 are for example only, and that numerous different connectivity arrangements are possible.

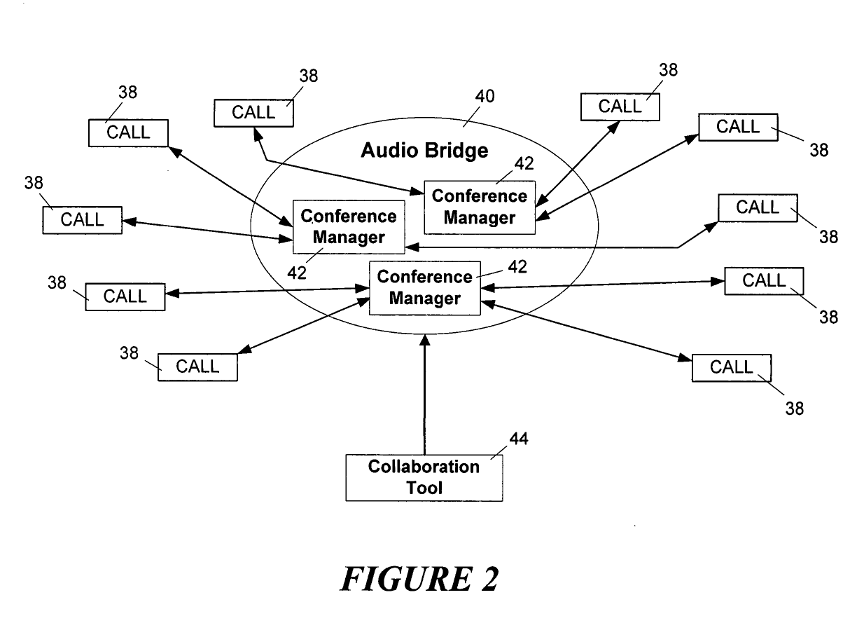

The collaboration tool provides a number of unique functions that simplify and enhance distributed meetings, making them more effective. A critical part of the collaboration tool is the audio interconnection, which allows participants to have a voice conference from different remote locations. The illustration of FIG. 2 shows a graphic depiction of the audio bridge 40, which includes a conference manager 42 for each active conference, each conference manager managing simultaneous streams of packet-switched voice data, and rendering custom mixes of the data streams for each of the users. The manner in which the audio data for each call is mixed is directed by the collaboration tool 44, which provides the necessary instructions to the audio bridge. This custom mixing of the voice data is key to enabling a number of the useful features of the collaboration tool. FIG. 2 demonstrates this capability by the indication of a number of “calls” 38 that are connected to the audio bridge 40. Those skilled in the art will understand that these calls represent streams of audio data that are transmitted over the host network, and that the audio bridge 40 operates in concert with the collaboration tool. The performance of the audio bridge may be controlled via the command protocols of the collaboration tool, which may take a number of different forms. However, the audio bridge 40 itself processes the calls, providing the voice data mixing as appropriate for each.

In the present embodiment, the audio bridge is a java program, and the conference managers 42 are java classes operating with that program (JAVA is a registered trademark of Sun Microsystems, Inc., Santa Clara, Calif.). Shown graphically in FIG. 2 are the conference managers 42, each of which is spawned by the audio bridge as needed. The conference managers govern the processing of all of the calls for a particular conference, as multiple conferences may be managed by the audio bridge simultaneously.

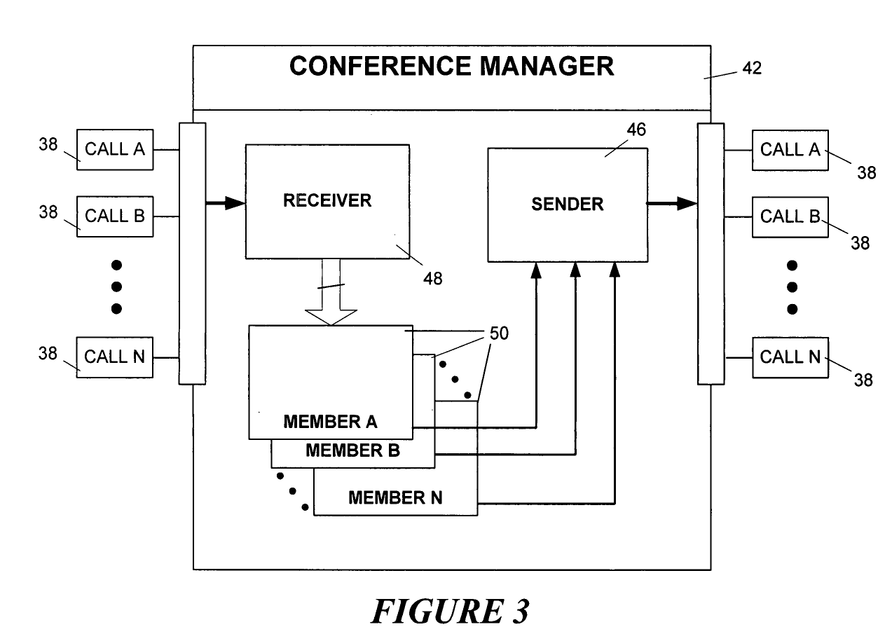

FIG. 3 is a general overview of a conference manager 42 that may be used with the present invention. The conference manager 42 oversees the processing of the voice data that is communicated between the participants of a given conference. The two-way audio connections of the conference participants, represented by calls 38, originate at different connection points from which the participants may have audio access to the conference over the network. Each of the participants is provided with a customized mix of audio inputs from the other participants, each mix depending on the current rules established in the conference. As shown in the figure, audio data is input and output from the conference manager. Each of the calls is connected via a network socket that is accessed by the conference manager. The input audio data collected from the participants to the conference is received by receiver 48 as it arrives. In this example, the audio data is organized using real-time transport protocol (RTP), in a manner known in the art. Thus, the audio stream is a sequence of data packets that are collected by the receiver 48.

In this example, the receiver 48, as well as the sender 46, is an instantiation of a java class. As part of the conference manager, a set of member objects 50 are created, each one representing a different one of the calls 38. Each member object maintains a mixing protocol for its particular call, and ensures that the correct audio mix is provided for that call. The receiver thread, upon receiving data from a particular call, sends a request to the appropriate member object 50 to process the received data. It should be noted that, in this embodiment, all of the input data received by the receiver is handled by a single receiver thread. However, it may be desirable to have multiple receiver threads, so as to split up the packet processing tasks. Nevertheless, the number of receiver threads is independent of the number of member objects. The sender, as discussed below, is also a single thread, or a number of threads otherwise independent of the number of member objects. With the number of input and output threads being independent of the number of member objects, the number of conference participants is flexible, and may be easily increased or decreased as desired for the conference. This provides a simple scalability for an environment in which the number of conference participants is unknown prior to the conference being established, and for which the number of participants may change during the conference.

Each of the member objects maintains a linked list to which packets that it receives are appended as they arrive. The use of linked lists, in general, is well known in the art, and will not be described in any further detail herein. In addition, while linked lists are used in the exemplary embodiment, other types of lists may also be used instead. Each member object is also responsible for modifying the data that will be output to its call. To do this, the packet data must be modified relative to the data of other packets from the same time interval, and forwarded to the sender 46, which then outputs it to the appropriate call 38. Although the receiver processes all incoming data packets as they arrive, the system maintains a regular time cycle in that the sender processes packets regularly, such as every 20 ms. Thus, for any given member object, data is forwarded by the receiver as it arrives, and each packet is appended to a linked list. Every time cycle, the sender thread processes and removes the first packet in the linked list for each member. This is done by the sender making a request for the member to calculate the packet to be output, processing the mixed packet, and delivering it to the appropriate call via one of the socket associated with that call.

The actual mixing involves the adding and subtracting of audio contributions of the different participants, depending on which contributions each participant is supposed to receive. The mixing may be done in the VoIP domain, so that conventional voice signals are packetized before mixing, while the signals from software phones using the VoIP protocol may be processed directly.

The functionality of the collaboration tool may allow for multiple conversations to take place within the same conference, with some or all of the audio inputs to be excluded from the audio mix of certain participants. Another function is to customize the packets that are distributed to the calls receiving them. One task in this regard is to remove, from the mixed packet sent to a particular call, the contribution of that call. Thus, the audio contribution of a participant is excluded from the audio received by that participant, for example, to remove the perception of an echo.

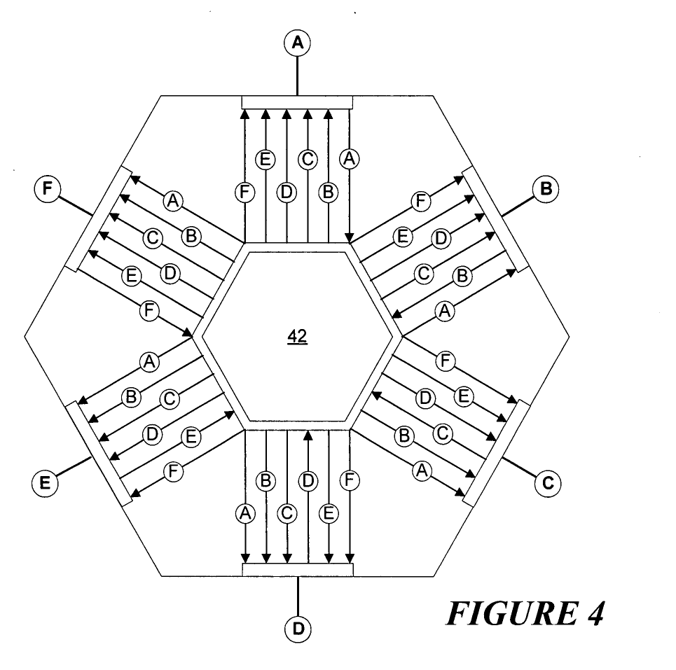

To demonstrate mixing strategies used in the present invention, FIGS. 4-6 show how audio contributions may be distributed to conference participants under different circumstances. Those skilled in the art will recognize that these diagrams are for illustration only, and do not represent a specific configuration of the system components.

FIG. 4 is a graphical depiction of how the audio streams are mixed among participants to a conference where all of the participants are listening and speaking in a single forum. Each of the meeting participants is represented by a node connected to a network over which audio data is transmitted to and from the participants. In fact, the nodes may more accurately be described as representing calls, since some of the calls may not be from just a single participant, but for the purposes of this example the nodes will be considered participants. In this example, there are six nodes, labeled A through F, representing six meeting participants that each provide an audio input to the meeting, and that each receive an output audio mix. The audio connection between any of the nodes and the network consists of an audio input, which is typically a voice input from the user represented by that node, and an audio output, which is some mix of voice data from the other meeting participants. To demonstrate the mixing strategies according to the present invention, the voice data of each participant is represented in FIG. 4 by an arrow identified by the node letter representing that participant. The arrows are located between the various participant nodes and a central hub which is labeled 42, since the mixing tasks of the hub are carried out by the conference manager 42 shown in FIGS. 2 and 3. The arrows indicate which voice data is transmitted to and from which node.

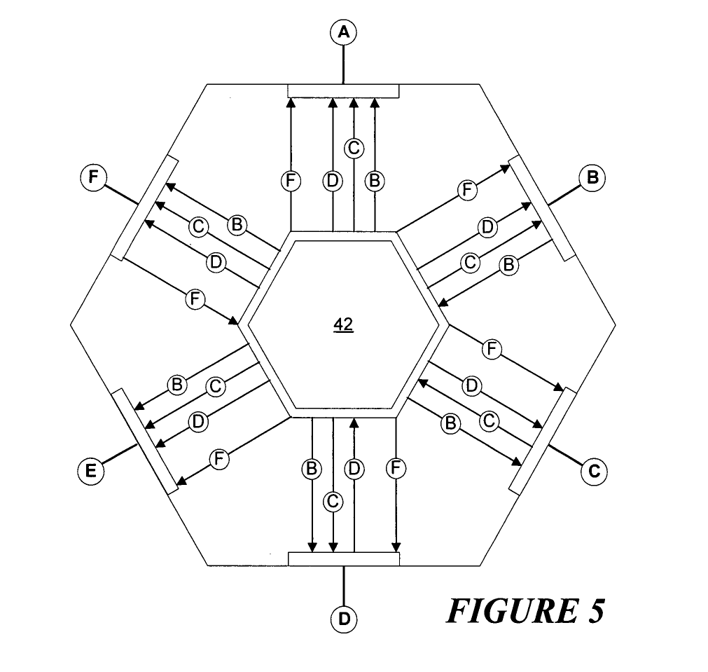

FIG. 4 represents a meeting in which no conference subgroups have been formed, and for which none of the participants have muted his or her audio input. Thus, for each node, there is an input audio signal to the hub 42 from that node, and equal output audio contributions from each of the other nodes. That is, each participant can speak and be heard by all of the other meeting participants, but each has his or her own contribution removed from the audio mix being received. FIG. 5 represents a situation in which there are no conference subgroups established, but in which two participants, “A” and “E,” have muted their audio inputs, perhaps in an effort to limit extraneous noise. As shown, this results in there being no audio inputs from nodes “A” or “E” and, as such, no audio contributions are received from “A” and “E” by the other nodes. Of course, all of the nodes still receive audio contributions from nodes B, C, D and F, whose participants may speak and be heard in the meeting.

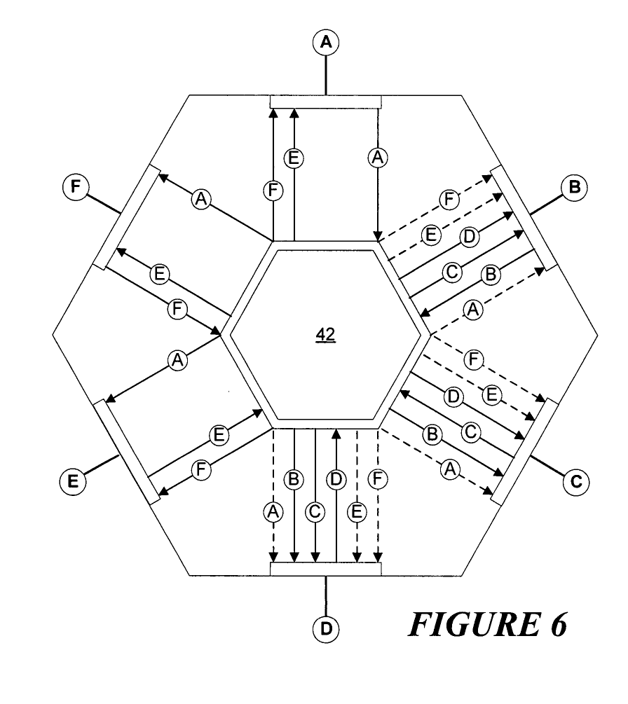

The initiation of a conference subgroup within the main conference also has effects on the audio inputs and outputs. In certain circumstances it may be possible to create a subgroup within a primary conference that allows a subset of the conference participants to have a private conversation without the remaining participants being able to hear them. From a situation in which there are no current subgroup conferences, and none of the meeting participants has his or her audio muted (as in FIG. 4), the initiation of a subgroup conference has effects on the audio contributions as shown in FIG. 6.

In this example, the participants in the subgroup are those parties represented by nodes “B,” “C” and “D.” In this example, when selected participants join the subgroup, the audio for those participants is muted in the main conference. As a result, the audio contributions of “B,” “C” and “D” are no longer received by “A,” “E” and “F,” but are still received by the parties to the subgroup. The particular rules of the collaboration tool will also affect how the audio from the main conference is handled. In this example, the audio from the main conference, now limited to the contributions of “A,” “E” and “F,” is still heard by the participants to the subgroup, only at an attenuated volume. This is indicated in FIG. 6 by the arrows representing those audio contributions being shown in broken lines. Of course, those not participating in the subgroup still hear the main meeting audio contributions at full volume. Other rules, such as completely preventing the audio from the main conference from being received by the subgroup members, may also be employed.

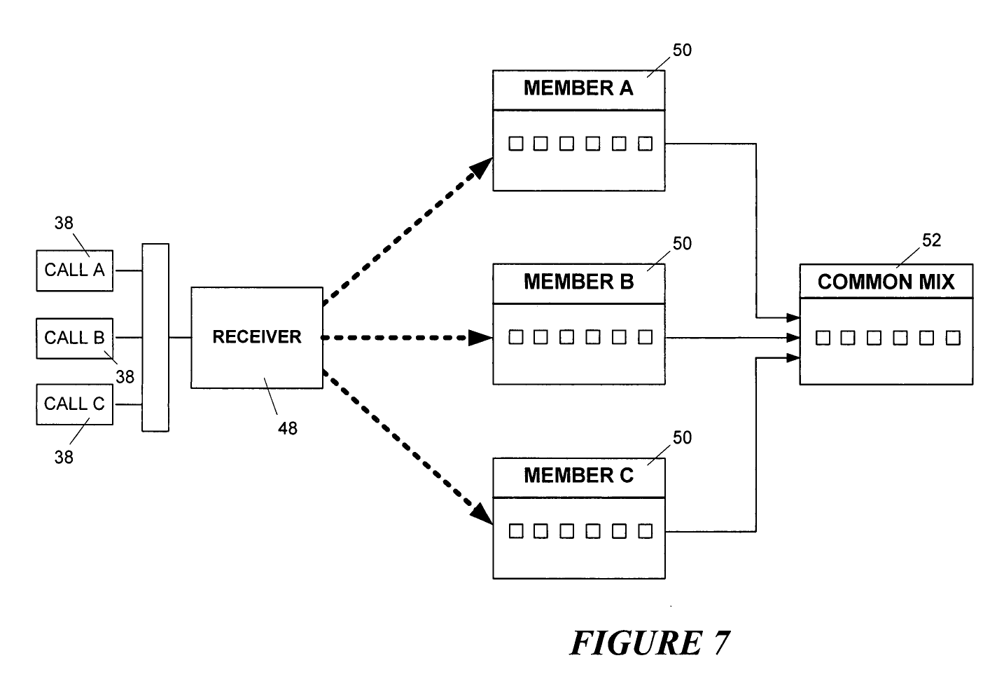

As there are different mixing strategies that may be desired, the conference manager 42 (FIG. 3) must distribute audio data packets appropriately to each of the calls. FIG. 7 shows a graphical depiction of how input packets are processed by the conference manager. Receiver 48 receives incoming packets from the audio inputs present in the conference. The data received by the receiver would typically have a sampling rate and channels that correspond to the incoming calls. This data may be resampled to the preferred sampling rate and channels selected for the conference.

The receiver forwards each packet to the member object that represents the source of the packet. In FIG. 7, there are only three member objects depicted, but those skilled in the art will understand that there may be many more simultaneous active member objects. Each of the member objects 50 maintains the information regarding its particular mix and, upon receiving a packet attributable to its member, it decodes the packet and the decoded packet is appended to a linked list maintained by the member object. The packet data is then added to a common mix object 52 that maintains its own linked list made up of the contributions of all the input calls. The common mix packets are not required to practice the invention, but are a useful mechanism for creating certain types of mixes, as described in more detail hereinafter.

How the data is combined for each outgoing call depends on the mixing arrangement of the conference in question. In a very basic arrangement, where all parties are actively participating in a single discussion, the mix for a user includes all of the input data for the appropriate time segment, but with that user's own contribution subtracted from the mix. Conferences that have more complicated mixes, such as would be required for subgroup conferences, require different combinations of packets from the various members. For example, if there is a subgroup conference between two participants, their audio contributions are withheld from the other conference participants while the subgroup conference is taking place. Thus, for each of the main conference participants that is not participating in the subgroup conference, the data sent to that participant would include the contributions of each of the other participants in the main conference, with the contributions of the participants to the subgroup subtracted (along with the contribution of the participant receiving the mix). Thus, each of the mixing functions requires access to the packets of all the contributors.

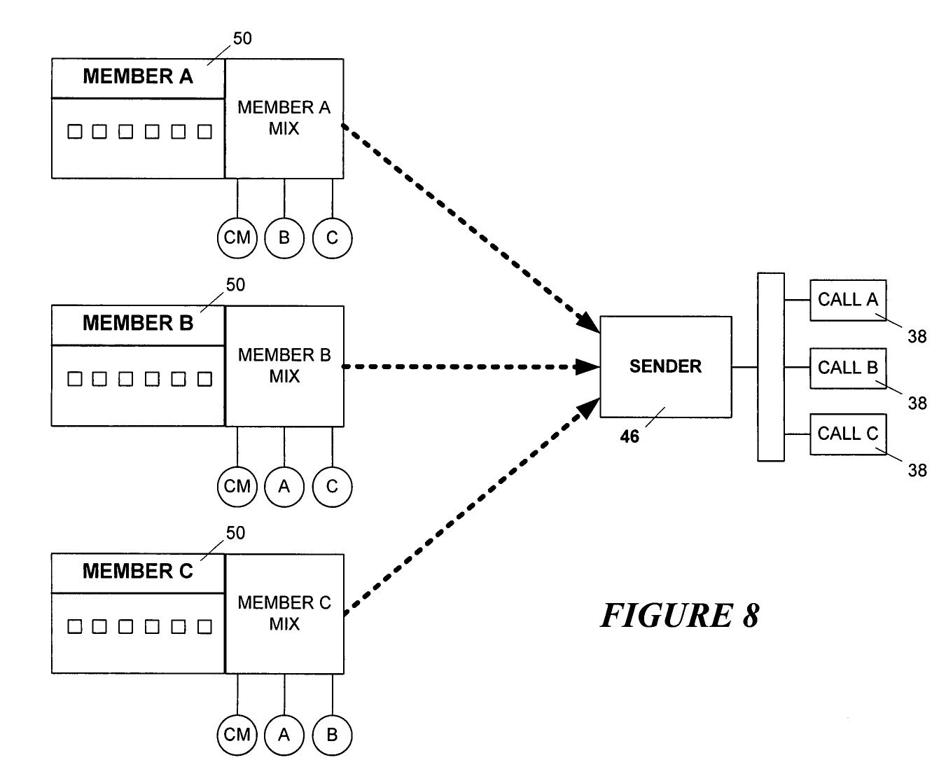

FIG. 8 is a graphical depiction of the output functionality of the conference manager. Three member objects 50 are shown in the figure to demonstrate the mixing process, but those skilled in the art will recognize that there may be many more member objects in actuality, depending on the number of conference participants. The member objects 50 are shown as having a linked list of their own packets (similar to the depiction of FIG. 7), but also as having a mixing functionality that prepares output packets.

Each of the member objects is responsible for preparing the packets to be delivered to the participant represented by that particular object. In order to prepare whichever custom mix is necessary for a given participant, each member object is given access to the packets of the other member objects. This is represented in FIG. 8 by inputs to the mixing functionality of the member objects, each of which is identified by a letter that designates the member object that is the source of the input. Also made available to each of the member objects are the packets of the common mix which, as discussed above, is a sequence of packets each of which is a combination of all the packets received by the member objects during a particular time segment. That is, the common mix is an audio mix of all the audio data input to the conference manager.

The audio outputs from the member objects are assembled by each member object combining the audio packets as appropriate for their respective conference participants. In this example, the incoming packets are decoded by the member objects to put them in a format that allows them to be easily mixed. For example, linear PCM format allows for combinations of different audio packets by simple addition or subtraction, although other formats may be used as well. In a linear PCM format, the audio mixing is performed by each member object performing packet combinations. For example, for a simple conference structure in which all participants can speak and listen in a common forum (like that represented in FIG. 4), each member object would create audio packets that include the contributions of all participants except the participant represented by that object. To assemble such a packet, the member object could combine all of the packets of all of the participants except itself for the time segment in question. Alternatively, and more efficiently, the member object would use the common mix packet for that time segment, and subtract its own packet for that time segment, i.e., the contribution of the participant that it represents.

Those skilled in the art will recognize that the creation of audio output packets to be output from a particular member object is a matter of that member object combining different packets as necessary to create the custom mix that has been designated for the participant represented by that member object. So, if some participants are participating in a subgroup conference, the audio contributions from those participants would be omitted from the output to the other participants. Thus, the member objects for those other participants could create an output mix by adding together packets (other than the common mix packets), while omitting the packets from those participants participating in the subgroup conference. Alternatively, the mix could be created by using the common mix packet and subtracting the packets from those participants in the subgroup conference. It will be recognized that any number of variations in the output mix may be thus created, and each is considered to be within the scope of the invention. Moreover, it may be desirable to construct the common mix packets from less than all of the input audio data. For example, when a subgroup conference is created, it may be desirable to omit the audio inputs of the subgroup conference participants from the common mix. This would then simplify the creation of an output mix for any participants in the main conference that are not participants in the subgroup conference. Those skilled in the art will understand that any number of different mixing strategies may be used, and those various strategies are all considered to be within the scope of the invention.

The packets created by the member objects 50 are output via a sender 46. As mentioned above, the sender sends a request to the member objects for audio packets to be output, processes them, and forwards them to the correct calls 38. Because the number of receiver and sender threads are independent of the number of member objects, it allows for the easy scalability of the system to accommodate as many participants as desired. Thus, the number of member objects may be expanded and reduced as necessary, without affecting the operation of the audio bridge. This high degree of scalability greatly facilitates the handling of audio data mixing in the collaboration tool, requiring no special modifications for changing the number of calls that are party to a particular conference.

While the invention has been shown and described with reference to a preferred embodiment thereof, it will be recognized by those skilled in the art that various changes in form and detail may be made herein without departing from the spirit and scope of the invention as defined by the appended claims.

What is claimed is:

1. An audio management apparatus for managing simultaneous streams of packet-switched audio data for a network conference tool that provides communication between a plurality of different connection points, audio data being received from and transmitted to the connection points by the audio management apparatus, the apparatus comprising:
a plurality of member objects, each being associated with a different one of the connection points and each maintaining a mixing protocol for audio data to be delivered to the connection point with which it is associated, each member object modifying the packets that it receives to provide a mix of audio data corresponding to its mixing protocol and outputting the modified packets;
a receiver that receives each packet of audio data directed to the audio management apparatus, identifies the connection point that is the source of the packet, and forwards it to the member object that is associated with that connection point; and
a sender that processes each packet of audio data from each member object and transmits each packet to the connection point with which the packet is associated.

2. An audio management apparatus according to claim 1 wherein the audio management apparatus is a first audio management apparatus, and wherein there are a plurality of audio management apparatuses that operate simultaneously with the network conference tool to provide management of the audio data mixing for a plurality of respective conferences.

3. An audio management apparatus according to claim 1 wherein each member object maintains a list of audio data packets for the connection point with which it is associated.

4. An audio management apparatus according to claim 3 further comprising a common mix object which maintains a list of audio data packets each comprising a combination of audio data packets of a plurality of the member objects for one particular time segment.

5. An audio management apparatus according to claim 3 wherein each member object modifies the packets that it receives by adding or subtracting packets for a common time sequence with one another.

6. An audio management apparatus according to claim 5 wherein each member object has access to the data packets of the other objects.

7. An audio management apparatus according to claim 1 wherein the apparatus has at least one receiver thread and at least one sender thread, and wherein the number of member objects is independent of the number of receiver and sender threads.

8. A method for managing simultaneous streams of packet-switched audio data for a network conference tool that provides communication of audio data between a plurality of different connection points, the method comprising:
maintaining, with a plurality of member objects, a mixing protocol for audio data to be delivered to the connection points, each member object being associated with a different one of the connection points and each member object modifying the packets that it receives to provide a mix of audio data corresponding to its mixing protocol and outputting the modified packets;
receiving each packet of audio data directed to the audio management apparatus with a receiver that identifies the connection point that is the source of the packet, and forwards the packet to the member object that is associated with that connection point; and
processing each packet of audio data from each member object with a sender that transmits each packet to the connection point with which the packet is associated.

9. A method according to claim 8 further comprising managing simultaneous streams of packet-switched audio data for a plurality of conferences, wherein each conference has its own set of multiple audio data streams such that the network conference tool provides management of the audio data mixing for each of the respective conferences.

10. A method according to claim 8 wherein each member object maintains a list of audio data packets for the connection point with which it is associated.

11. A method according to claim 10 further comprising maintaining a list of audio data packets with a common mix object, each common mix audio data packet comprising a combination of audio data packets of a plurality of the member objects for one particular time segment.

12. A method according to claim 10 wherein each member object modifies the packets that it receives by adding or subtracting packets for a common time sequence with one another.

13. A method according to claim 12 wherein each member object has access to the data packets of the other objects.

14. A method according to claim 8 wherein the method uses at least one receiver thread and at least one sender thread, and wherein the number of member objects is independent of the number of receiver and sender threads.

15. An audio management apparatus for managing simultaneous streams of packet-switched audio data for a network conference tool that provides communication between a plurality of different connection points, audio data being received from and transmitted to the connection points by the audio management apparatus, the apparatus comprising:
means for maintaining, with a plurality of member objects, a mixing protocol for audio data to be delivered to the connection points, each member object being associated with a different one of the connection points and each member object modifying the packets that it receives to provide a mix of audio data corresponding to its mixing protocol and outputting the modified packets;
means for receiving each packet of audio data directed to the audio management apparatus with a receiver that identifies the connection point that is the source of the packet, and forwards the packet to the member object that is associated with that connection point; and
means for processing each packet of audio data from each member object with a sender that transmits each packet to the connection point with which the packet is associated.

16. An audio management apparatus according to claim 15 wherein each member object maintains a list of audio data packets for the connection point with which it is associated.

17. An audio management apparatus according to claim 16 further comprising means for maintaining a list of audio data packets with a common mix object, each common mix audio data packet comprising a combination of audio data packets of a plurality of the member objects for one particular time segment.

18. An audio management apparatus according to claim 16 wherein each member object modifies the packets that it receives by adding or subtracting packets for a common time sequence with one another.

19. An audio management apparatus according to claim 18 wherein each member object has access to the data packets of the other objects.

20. An audio management apparatus according to claim 15 wherein the method uses at least one receiver thread and at least one sender thread, and wherein the number of member objects is independent of the number of receiver and sender threads.
